(19) United States
(12) Patent Application Publication
(10) Pub. No.: US 2024/0004251 A1
(43) Pub. Date: Jan. 4, 2024

(54) APPARATUS INCLUDING A CONTROL DEVICE AND A METHOD OF USING THE SAME

(71) Applicant: SAGE ELECTROCHROMICS, INC., Faribault, MN (US)

(72) Inventors: Ahoo MALEKAFZALI ARDAKAN, Cottonwood Heights, UT (US); Leo SU, Lakeville, MN (US); Bryan D. GREER, Northfield, MN (US); David J. BEST, Elysian, MN (US)

(21) Appl. No.: 18/340,258

(22) Filed: Jun. 23, 2023

Related U.S. Application Data
(60) Provisional application No. 63/367,454, filed on Jun. 30, 2022.
(60) Provisional application No. 63/373,003, filed on Aug. 19, 2022.

(51) Int. Cl. G02F 1/153; G02F 1/163; G02F 1/1523

(52) U.S. Cl. CPC G02F 1/1533; G02F 1/163; G02F 1/1523; G02F 2001/15145

(57) ABSTRACT

An apparatus can include an apparatus. The apparatus can include two or more electrochromic devices in at least two rows. The two or more electrochromic devices can include a first electrochromic device in a first row with a graded transmission state and a second electrochromic device in a second row with a graded transmission state. The apparatus can further include a control device configured to generate a graded transmission pattern for the two or more electrochromic devices, where the gradient transmission state of the first electrochromic device is a mirror to the gradient transmission state of the second electrochromic device.

### CROSS-REFERENCE TO RELATED APPLICATION(S)

This application claims priority under 35 U.S.C. § 119(e) to U.S. Provisional Application No. 63/367,454, entitled “APPARATUS INCLUDING A CONTROL DEVICE AND A METHOD OF USING THE SAME,” by Ahoo MALEKAFZALI ARDAKAN et al., filed Jun. 30, 2022, and this application claims priority under 35 U.S.C. § 119(e) to U.S. Provisional Application No. 63/373,003, entitled “APPARATUS INCLUDING A CONTROL DEVICE AND A METHOD OF USING THE SAME,” by Ahoo MALEKAFZALI ARDAKAN et al., filed Aug. 19, 2022, which are both assigned to the current assignee hereof and incorporated herein by reference in their entireties.

### FIELD OF THE DISCLOSURE

The present disclosure is directed to systems that include non-light-emitting variable transmission devices, and more specifically to controls for non-light-emitting variable transmission devices and methods of using the same.

### BACKGROUND

A non-light-emitting variable transmission device can reduce glare and the amount of sunlight entering a room or passenger compartment. Non-light-emitting variable transmission devices, such as electrochromic (EC) devices, employ materials capable of reversibly altering their optical properties following electrochemical oxidation and reduction in response to an applied potential. The optical modulation is the result of the simultaneous insertion and extraction of electrons and charge compensating ions in the electrochemical material lattice. Conventionally, an electrochromic device can be at a particular transmission state. For example, the electrochromic device may be set to a certain tint level (i.e., a percentage of light transmission through the electrochromic device), such as full tint (e.g., 0% transmission level), full clear (e.g., 63%+/−10% transmission level).

There are several means by which an electrochromic device can switch between tint and clear states. For example, there can be manual control or control based on a series of algorithms. Those algorithms can take into account variations in the voltages needed, the resistance within the device, or the power needs to run multiple devices. Knowing and understanding the parameters for control of the devices can help optimize performance of the device. However, as the number of electrochromic devices increase or the complexity of the pattern of switching increases so too does the complexity of controlling the devices. As such, a need exists for a better control strategy for more than one electrochromic device and specifically a need exists for a better control strategy that can be implemented by facilities personnel, or even the occupant that may not be a programmer or familiar with a building's facilities.

### BRIEF DESCRIPTION OF THE DRAWINGS

Embodiments are illustrated by way of example and are not limited in the accompanying figures.

FIG. 1 includes a schematic depiction of a system for controlling a set of non-light-emitting, variable transmission devices in accordance with an embodiment.

FIG. 2 includes an illustration of a top view of a non-light emitting, variable transmission device, according to one embodiment.

FIGS. 3A and 3B each include an illustration of a cross-sectional view of the non-light emitting, variable transmission device of FIG. 2, according to one embodiment.

FIG. 4 includes an illustration of standard controls for stacked gradient electrochromic devices in a façade.

FIG. 5 includes an illustration of controls for stacked gradient electrochromic devices in a façade, according to one embodiment.

FIG. 6 shows an illustration of various embodiments of graded transmission within a façade, according to one embodiment.

FIG. 7 shows an illustration of various embodiments of graded transmission within a façade, according to one embodiment.

FIG. 8 includes a method of operating the system of FIG. 1, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

The term “color rendering,” when referring to an electrical device, is intended to refer to the amount of light transmission permitted through an electrochromic window for a space to keep the color within the space within a wavelength of between 680 nm and 720 nm and can be defined by the CIELAB color space L*a*b*.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the infrastructure controls for a building or vehicle and within the electrochromic arts.

A control device can be configured to control a façade of one or more gradient switchable devices in response to receiving an input corresponding to state information. The window may include architectural glass used for a skylight or a wall of a building or may include a moon roof or a side window of a vehicle. The control device can be part of an apparatus that includes the window and switchable devices. In an embodiment, the control device can include a remote portion outside a controlled space and a local portion within the control space. The remote portion may be located or coupled to other building environmental controls, and the local portion may supply proper voltages to the switchable devices to achieve the desired scene.

The methods of controlling the façade can be performed by an occupant of the controlled space, if needed or desired. The apparatus and method are better understood after reading this specification in conjunction with the accompanying figures.

The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

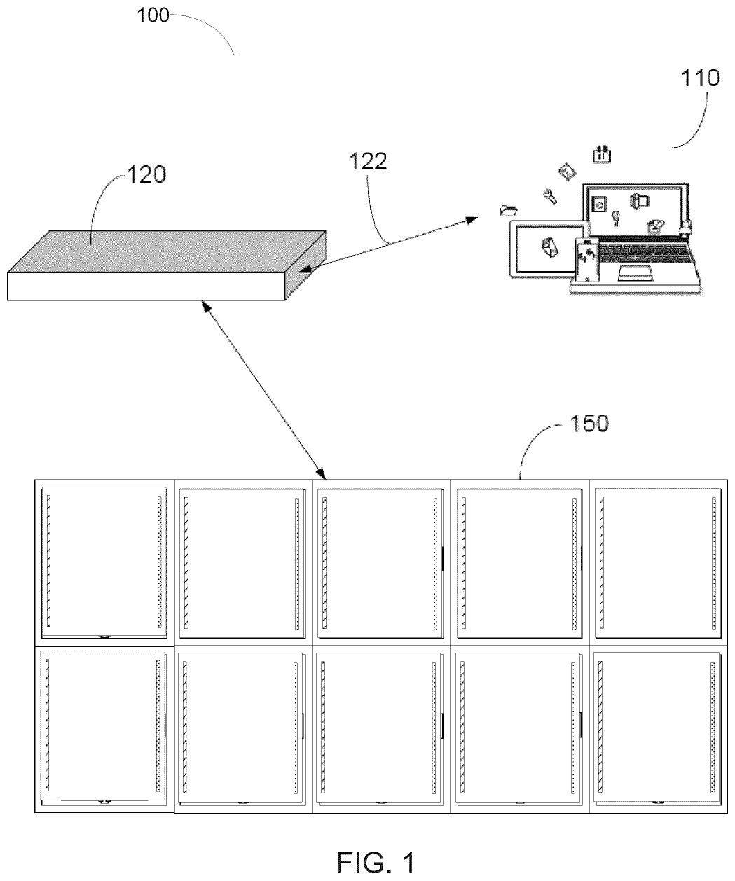

Referring to FIG. 1, a system for controlling a set of non-light-emitting, variable transmission devices is illustrated and is generally designated 100. The non-light-emitting, variable transmission devices can be electrochromic devices. The system 100 can include logic to control the operation of the heating ventilation air condition (HVAC) system of the building, interior lighting, exterior lighting, emergency lighting, fire suppression equipment, elevators, escalators, alarms, security cameras, access doors, another suitable component or sub-system of the building, or any combination thereof. The logic for the control management system 110 can be in the form of hardware, software, or firmware. In a particular embodiment, the logic can be within a computing device such as a desk top computer, a laptop computer, a tablet computer, a smartphone, some other computing device, or a combination thereof. The logic may be in a separate location from the non-light-emitting, variable transmission devices. In an embodiment, the logic may be stored in a field programmable gate array (FPGA), an application-specific integrated circuit (ASIC), a hard drive, a solid state drive, or another persistent memory. In an embodiment, the control management system 110 may include a processor that can execute instructions stored in memory within the control management system 110 or received from an external source.

The system 100 can be used to regulate the transmission of an insulated glazing unit (IGU) installed as part of architectural glass along a wall of a building or a skylight, or within a vehicle as well as to evaluate the performance of the one or more IGU's. As depicted, the system 100 can include a processor 110, a controller 120, and a frame panel 150.

As illustrated in FIG. 1, the controller 120 can be connected to the processor system 110 via a control link 122. The control link 122 can be a wired connection, such as in a local area network or Ethernet network. The control link 122 can be a wireless connection. In an embodiment, the control link 122 can use a wireless local area network connection operating according to one or more of the standards within the IEEE 802.11 (WiFi) family of standards. In a particular aspect, the wireless connections can operate within the 2.4 GHz ISM radio band, within the 5.0 GHz ISM radio band, or a combination thereof. Regardless of the type of control link 122, the processor 110 can provide control signals to the controller 120 via the control link 122. The control signals can be used to control the operation of one or more non-light-emitting variable transmission devices that are indirectly, or directly, connected to the controller 120. In another embodiment, signals from the controller 120 can go to the processor 110 via the control link 122.

In an embodiment, the building management system 110 may include a processor that can execute instructions stored in memory within the building management system 110 or received from an external source. In one embodiment, the external source can include a rooftop device. In one embodiment, the external source can include data from one or more sensors used to provide information for controlling the one or more non-light emitting, variable transmission devices within the window frame 150. In one embodiment the external sensors can include 360 degree sensors. In another embodiment, the external sensors can include 180 degree sensors. Each sensor can return measurements on LUX, temperature, irradiance, direction, levels of light, weather measurements, and orientation, and more. In one embodiment, the sensor can be powered by either 24 V or power over Ethernet (POE). By combining the data from the plurality of sensors, the processor can receive data from a 360 degree field of view. In one embodiment, data from a single sensor can be taken. As such, the processor can receive data from between a 5 degree and 360 degree field of view based from a central point of the device. Each sensor can be provided information related to light intensity, temperature, sun position, time of day, calendar day, level of cloudiness, or another suitable parameter, or any combination thereof.

As seen in FIG. 1, the window frame panel 150 can include a plurality of non-light-emitting, variable transmission devices. In the embodiment as illustrated, the controller may be electrically connected to one or more non-light-emitting, variable transmission devices. In another embodiment, a different number of non-light-emitting, variable transmission devices, a different matrix of the non-light-emitting, variable transmission devices, or both may be used. In yet another embodiment, one or more controllers may be connected to both the controller and the one or more non-light-emitting, variable transmission devices. The controllers (not pictured) can be used to control operation of the non-light-emitting, variable transmission devices. Each of the non-light-emitting, variable transmission devices may be on separate glazings. In another embodiment, a plurality of non-light-emitting, variable transmission devices can share a glazing. In another embodiment, a pair of glazings in the window frame panel 150 can have different sizes, such glazings can have different numbers of non-light-emitting, variable transmission devices. After reading this specification, skilled artisans will be able to determine a particular number and organization of non-light-emitting, variable transmission devices for a particular application.

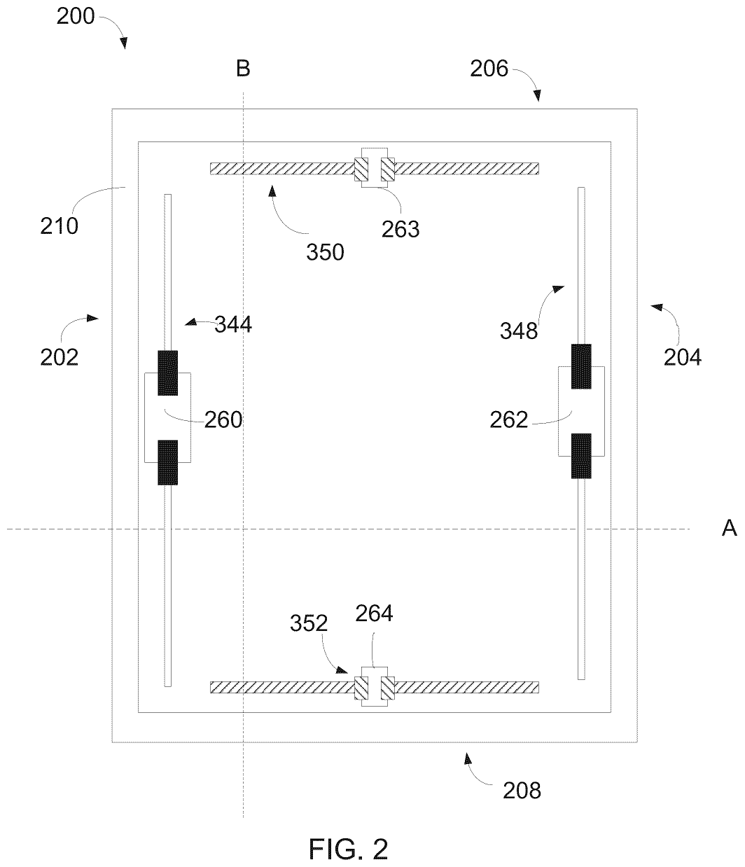

The system can be used with a wide variety of different types of non-light-emitting variable transmission devices, as described in more detail with respect to FIG. 2. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

The description with respect to FIG. 2 provides exemplary embodiments of a glazing that includes a glass substrate and a non-light-emitting variable transmission device disposed thereon. The embodiment as described with respect to 2, 3A, and 3B is not meant to limit the scope of the concepts as described herein. For purposes of illustrative clarity, the non-light-emitting variable transmission device 200 can be an electrochromic device. In the description below, a non-light-emitting variable transmission device will be described as operating with voltages on bus bars being in a range of 0 V to 3 V. Such description is used to simplify concepts as described herein. Other voltage may be used with the non-light-emitting variable transmission device or if the composition or thicknesses of layers within an electrochromic stack are changed. The voltages on bus bars may both be positive (1 V to 4 V), both negative (−5 V to −2 V), or a combination of negative and positive voltages (−1 V to 2 V), as the voltage difference between bus bars are more important than the actual voltages. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims.

FIG. 2 is an illustration of a top view of a substrate 210, a stack of layers of an electrochromic device 322, 324, 326, 328, and 330, and bus bars 344, 348, 350, and 352 overlying the substrate 210, according to one embodiment. In an embodiment, the substrate 210 can include a glass substrate, a sapphire substrate, an aluminum oxynitride substrate, or a spinel substrate. In another embodiment, the substrate 210 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 210 may or may not be flexible. In a particular embodiment, the substrate 210 can be float glass or a borosilicate glass and have a thickness in a range of 0.5 mm to 4 mm thick. In another particular embodiment, the substrate 210 can include ultra-thin glass that is a mineral glass having a thickness in a range of 50 microns to 300 microns. In a particular embodiment, the substrate 210 may be used for many different non-light-emitting variable transmission devices being formed and may be referred to as a motherboard.

The bus bar 344 lies along a side 202 of the substrate 210 and the bus bar 348 lies along a side 204 that is opposite the side 202. The bus bar 350 lies along a side 206 of the substrate 210, and the bus bar 352 lies along a side 208 that is opposite side 206. Each of the bus bars 344, 348, 350, and 352 have lengths that extend a majority of the distance on each side of the substrate. In a particular embodiment, each of the bus bars 344, 348, 350, and 352 have a length that is at least 75%, at least 90%, or at least 95% of the distance between the sides 202, 204, 206, and 208, respectively. The lengths of the bus bars 344 and 348 are substantially parallel to each other. As used herein, substantially parallel is intended to mean that the lengths of the bus bars 344 and 348, 350, and 352 are within 10 degrees of being parallel to each other. Along the length, each of the bus bars has a substantially uniform cross-sectional area and composition. Thus, in such an embodiment, the bus bars 344, 348, 350, and 352 have a substantially constant resistance per unit length along their respective lengths.

In one embodiment, the bus bar 344 can be connected to a first voltage supply terminal 260, the bus bar 348 can be connected to a second voltage supply terminal 362, the bus bar 350 can be connected to a third voltage supply terminal 263, and the bus bar 352 can be connected to a fourth voltage supply terminal 264. In one embodiment, the voltage supply terminals can be connected to each bus bar 344, 348, 350, and 352 about the center of each bus bar. In one embodiment, each bus bar 344, 348, 350, and 352 can have one voltage supply terminal. The ability to control each voltage supply terminal 260, 262, 263, and 264 provides for control over grading of light transmission through the electrochromic device 200.

In one embodiment, the first voltage supply terminal 260 can set the voltage for the bus bar 344 at a value less than the voltage set by the voltage supply terminal 263 for the bus bar 350. In another embodiment, the voltage supply terminal 263 can set the voltage for the bus bar 350 at a value greater than the voltage set by the voltage supply terminal 264 for the bus bar 352. In another embodiment, the voltage supply terminal 263 can set the voltage for the bus bar 350 at a value less than the voltage set by the voltage supply terminal 264 for the fourth bus bar 352. In another embodiment, the voltage supply terminal 260 can set the voltage for the bus bar 344 at a value about equal to the voltage set by the voltage supply terminal 262 for the bus bar 348. In one embodiment, the voltage supply terminal 260 can set the voltage for the bus bar 344 at a value within about 0.5 V, such as 0.4 V, such as 0.3 V, such as 0.2 V, such as 0.1 V to the voltage set by the voltage supply terminal 262 for the second bus bar 348. In a non-limiting example, the first voltage supply terminal 260 can set the voltage for the bus bar 344 at 0 V, the second voltage supply terminal 262 can set the voltage for the bus bar 348 at 0 V, the third voltage supply terminal 263 can set the voltage for the bus bar 350 at 3 V, and the fourth voltage supply terminal 264 can set the voltage for the bus bar 352 at 1.5 V.

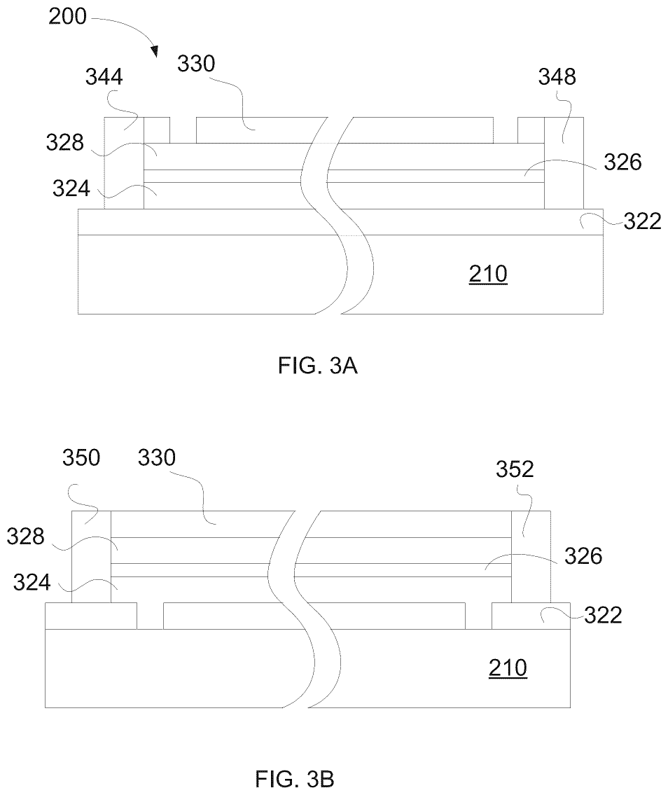

The compositions and thicknesses of the layers are described with respect to FIGS. 3A and 3B. Transparent conductive layers 322 and 330 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 322 and 330 can include gold, silver, copper, nickel, aluminum, or any combination thereof. The transparent conductive layers 322 and 330 can have the same or different compositions.

The set of layers further includes an electrochromic stack that includes the layers 324, 326, and 328 that are disposed between the transparent conductive layers 322 and 330. The layers 324 and 328 are electrode layers, wherein one of the layers is an electrochromic layer, and the other of the layers is an ion storage layer (also referred to as a counter electrode layer). The electrochromic layer can include an inorganic metal oxide electrochemically active material, such as WO₃, V₂O₅, MoO₃, Nb₂O₅, TiO₂, CuO, Ir₂O₃, Cr₂O₃, CO₂O₃, Mn₂O₃, or any combination thereof and have a thickness in a range of 50 nm to 2000 nm. The ion storage layer can include any of the materials listed with respect to the electrochromic layer or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 80 nm to 500 nm. An ion conductive layer 326 (also referred to as an electrolyte layer) is disposed between the electrode layers 324 and 328 and has a thickness in a range of 20 microns to 60 microns. The ion conductive layer 326 allows ions to migrate therethrough and does not allow a significant number of electrons to pass therethrough. The ion conductive layer 326 can include a silicate with or without lithium, aluminum, zirconium, phosphorus, boron; a borate with or without lithium; a tantalum oxide with or without lithium; a lanthanide-based material with or without lithium; another lithium-based ceramic material; or the like. The ion conductive layer 326 is optional and, when present, may be formed by deposition or, after depositing the other layers, reacting portions of two different layers, such as the electrode layers 324 and 328, to form the ion conductive layer 326. After reading this specification, skilled artisans will appreciate that other compositions and thicknesses for the layers 322, 324, 326, 328, and 330 can be used without departing from the scope of the concepts described herein.

The layers 322, 324, 326, 328, and 330 can be formed over the substrate 210 with or without any intervening patterning steps, breaking vacuum, or exposing an intermediate layer to air before all the layers are formed. In an embodiment, the layers 322, 324, 326, 328, and 330 can be serially deposited. The layers 322, 324, 326, 328, and 330 may be formed using physical vapor deposition or chemical vapor deposition. In a particular embodiment, the layers 322, 324, 326, 328, and 330 are sputter deposited.

In the embodiment illustrated in FIGS. 3A and 3B, each of the transparent conductive layers 322 and 330 include portions removed, so that the bus bars 344/348 and 350/352 are not electrically connected to each other. Such removed portions are typically 20 nm to 2000 nm wide. In a particular embodiment, the bus bars 344 and 348 are electrically connected to the electrode layer 324 via the transparent conductive layer 322, and the bus bars 350 and 352 are electrically connected to the electrode layer 328 via the transparent conductive layer 330. The bus bars 344, 348, 350, and 352 include a conductive material. In an embodiment, each of the bus bars 344, 348, 350, and 352 can be formed using a conductive ink, such as a silver frit, which is printed over the transparent conductive layer 322. In another embodiment, one or both of the bus bars 344, 348, 350, and 352 can include a metal-filled polymer. In a particular embodiment (not illustrated), the bus bars 350 and 352 are each a non-penetrating bus bar that can include the metal-filled polymer that is over the transparent conductive layer 330 and spaced apart from the layers 322, 324, 326, and 328. The viscosity of the precursor for the metal-filled polymer may be sufficiently high enough to keep the precursor from flowing through cracks or other microscopic defects in the underlying layers that might be otherwise problematic for the conductive ink. The lower transparent conductive layer 322 does not need to be patterned in this particular embodiment. In one embodiment, bus bars 344 and 348 are opposed each other. In one embodiment, bus bars 350 and 352 are orthogonal to bus bar 344.

While an exemplary embodiment of a continuously graded transmission state electrochromic is seen in FIGS. 3A and 3B, many different patterns for a continuously graded transmission state can be achieved by the proper selection of bus bar location, the number of voltage supply terminals coupled to each bus bar, locations of voltage supply terminals along the bus bars, or any combination thereof. In another embodiment, gaps between bus bars can be used to achieve a continuously graded transmission state. A continuous visible light transmission gradient can vary from about 63% transmission (least tinting—fully clear) on one end of a device to about 10% transmission at a second end on the opposite side of the device.

In another embodiment, the device 200 may include a plurality of layers between the substrate 210 and the first transparent conductive layer 322. In one embodiment, an antireflection layer can be between the substrate 210 and the first transparent conductive layer 322. The antireflection layer can include SiO₂, NbO₂, Nb₂O₅ and can be a thickness between 20 nm to 100 nm. The device 200 may include at least two bus bars with one bus bar 344 electrically connected to the first transparent conductive layer 322 and the second bus bar 348 electrically connected to the second transparent conductive layer 330.

Logic operations are described below with respect to a particular processor 110 with respect to an embodiment. In another embodiment, a logic operation described with respect to a particular processor 110 may be performed by another control device or be split between the control device and the processor 110. After reading this specification, skilled artisans will be able to determine a particular configuration that meets the needs or desires for a particular application.

The processor 110 can be coupled to the window frame 150 as well as one or more sensors. The processor 110 can receive signals corresponding to state information that can include a light intensity, an occupancy of a controlled space corresponding to the window, a physical configuration of the controlled space, a temperature, an operating mode of a heating or cooling system, a sun position, a time of day, a calendar day, an elapsed time since a scene has been changed, heat load within the controlled space, a contrast level between relatively bright and relatively dark objects within a field of view where an occupant is normally situated within the controlled space, whether an orb of the sun is in the field of view where the occupant is normally situated within the controlled space, whether a reflection of the sun is in the field of view where the occupant is normally situated within the controlled space, a level of cloudiness, or another suitable parameter, or any combination thereof. In another embodiment, the processor or I/O unit 110 can include a monitor and keyboard for a human to interact with the system 100.

The system 100 can be used to allow for scene-based control of electrochromic (EC) device within a window, such as an IGU installed as part of architectural glass along a wall of a building or a skylight, or within a vehicle. As the number and complexity of transmission of EC devices for a controlled space increases, the complexity in controlling the EC devices can also increase. Even further complexity can occur when the control of the EC devices is integrated with other building environmental controls. In an embodiment, the window can be skylight that may include over 900 EC devices. Coordinating control of such a large number of EC devices with other environmental controls can lead to very complicated control scenes, which some facilities personnel without extensive computer programming and experience with complex control systems may find very challenging.

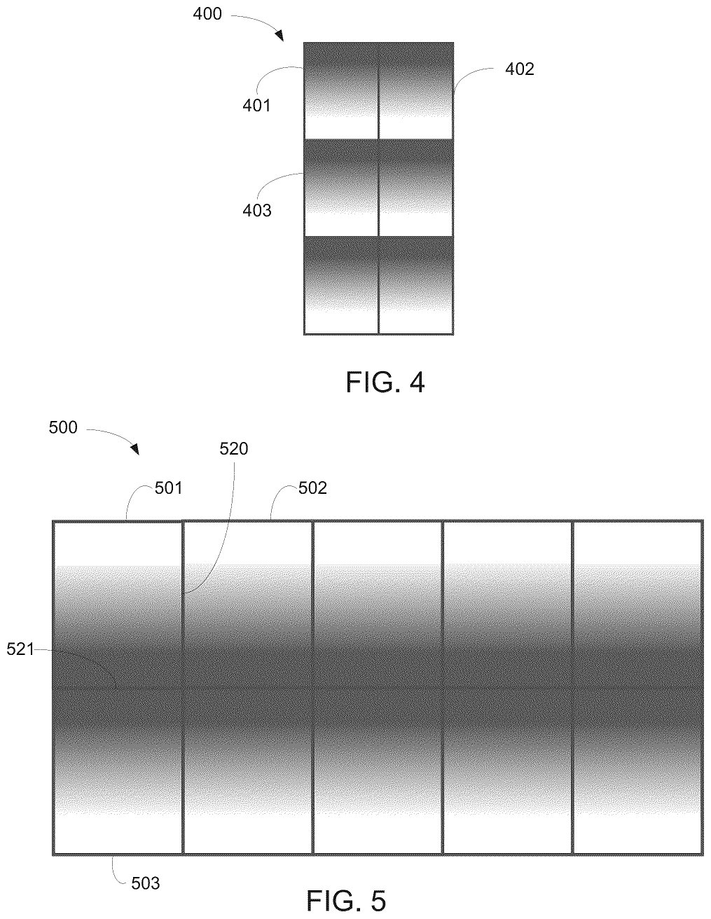

The inventors have discovered a multi-objective optimization tint pattern to control gradient EC devices that are in multiple rows and stacks. Specifically, controlling gradient EC devices such that control from the edge of one gradient EC device to the edge of another gradient EC device is continuous. FIG. 4 shows standard controls for stacked EC devices in a façade 400. As can be seen, a first gradient EC device 401 and a second gradient EC device 402, and a third gradient EC device 403 show the same gradient transmission. The first gradient EC device 401 is adjacent to the second gradient EC device 402 on a first side and adjacent to the third gradient EC device 403 on a second side, where the first side is orthogonal to the second side. In other words, the first gradient EC device 401 is stacked on the third gradient EC device 403 and horizontal to the second gradient EC device 402. As can be seen in FIG. 4, the gradient transmission of each device is the same, transitioning from a dark state to a light state.

FIG. 5 includes an illustration of controls for stacked gradient electrochromic devices in a façade 500, according to one embodiment. As can be seen in FIG. 5, the gradient EC device 501 has the same gradient transmission as the gradient EC device 502 but a mirror gradient transmission with gradient EC device 503. The first gradient EC device 501 is adjacent to the second gradient EC device 502 on a first side 520 and adjacent to the third gradient EC device 503 on a second side 521, where the first side 520 is orthogonal to the second side 521. In other words, the first gradient EC device 501 is stacked on the third gradient EC device 503 and horizontal to the second gradient EC device 502. The first gradient EC device 501 has a gradient transmission that is a mirror to both the second EC gradient device 502 and the third EC gradient device 503.

As can be seen in FIG. 5, in one embodiment any one of the EC gradient devices in the façade 500 has a gradient transmission that mirrors any two adjacent devices that share a side. In one embodiment any one of the EC gradient devices in the façade 500 has a gradient transmission that mirrors any three adjacent devices that share a side. In another embodiment, any one of the EC gradient devices in the façade 500 has a gradient transmission that minors any four adjacent devices that share a side. In one embodiment, the gradient transmission at the junction from one gradient EC device to a second EC device is a smooth transition with a matching transmission level. In one embodiment, the transmission state of the first gradient EC device 501 is the same as the transmission state of the second EC device 502, where both devices have a gradient transmission state. In one embodiment, the transmission state of the first gradient EC device 501 is a minor of the transmission state of the third gradient EC device 503, where both devices have a gradient transmission state. In one embodiment, the transmission state of the first gradient EC device 501 is the same as the transmission state of the second EC device 502 a mirror of the transmission state of the third gradient EC device 503, and where all three devices have a gradient transmission state.

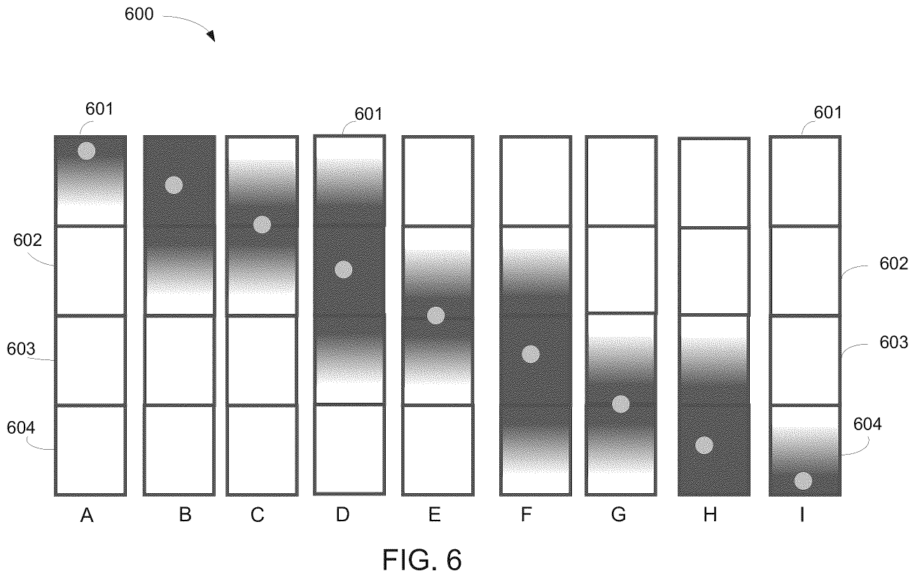

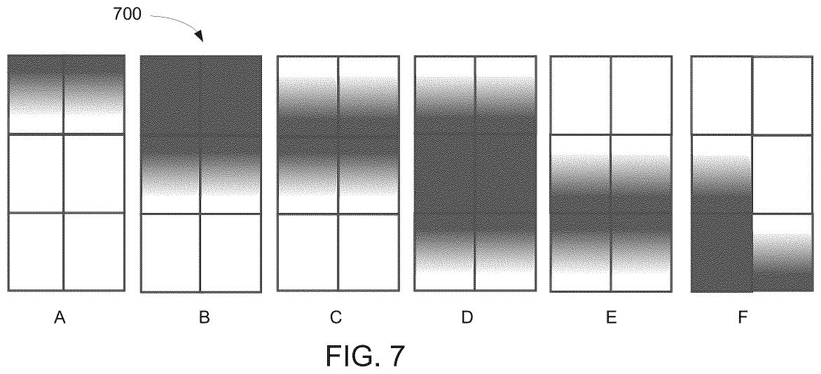

While the embodiments of FIG. 5 show two rows and five columns, more rows and columns could be included in the façade 500. In one embodiment, the façade 500 can have more than 2 rows and no greater than 500 rows. In one embodiment, the façade 500 can have more than 2 columns and no greater than 500 columns. In one embodiment, the façade 500 could include various shaped EC devices. In one embodiment, the façade 500 could include various sized EC devices. In one embodiment, the façade 500 could include gradient electrochromic devices in a variety of transmission states, as seen in FIGS. 6 and 7. In one embodiment, the façade 500 could include a combination of traditional electrochromic devices and gradient electrochromic devices.

The various transmission states of the one or more electrochromic devices can subsequently saved as learned scenes for controlling the entire façade 500. When using scene-based control of a window for a controlled space, scenes can be part of a collection, and the scene can be selected based on state information received by control devices. A scene generated for a controlled space may have been suitable for an original physical configuration of the controlled space; however, the scene may no longer be acceptable after the physical configuration has changed. For example, the original physical configuration for controlled space may have been a portion of a floor, including a cubicle room. Remodeling may be performed, and additional walls may be installed. The physical configuration of the controlled space may have changed in size and become different controlled spaces, one of which can be a conference room. Glare may be more problematic with the conference room, as compared to the controlled space with cubicles. Thus, a previously validated scene may no longer be acceptable. As such, before using the scenes, the collection of scenes can be generated for the gradient electrochromic devices.

The gradient transmission patterns may be better understood with particular examples that are described with respect to FIGS. 6 and 7. In the examples described, the EC devices will be in one of three states to simplify understanding of the concepts as described herein. The states include a high transmission state, a graded transmission state. The high transmission state may be at the highest level of transmission (fully bleach); however, it can be at another transmission level that is higher than the low transmission states. The low transmission state may be at the lowest level of transmission (fully tinted); however, it can be at another transmission level that is lower than the high transmission states. In actual practice, a continuum of transmission states can be used. After reading this specification, skilled artisans will be able to determine transmission states that will be used with the scenes.

FIGS. 6 and 7 show an illustration of various embodiments of graded transmission within a façade 600. FIG. 6 includes a façade 600 that includes four electrochromic devices, 601, 602, 603, 604 able to tint in a graded transmission state. The devices are configured in a vertical orientation with one stacked upon the other so that all four are in one column. EC device 602 is between EC device 601 and EC device 603, and EC device 603 is between EC device 602 and EC device 604. FIG. 6 includes the four electrochromic devices at various stages A-I. Column A shows EC device 601 with a graded transmission and EC devices 602, 603, and 604 with fully clear transmission states. Column B shows EC device 601 with a fully tinted transmission state, EC device 602 with a graded transmission and EC devices 603 and 604 with fully clear transmission states. Column C shows EC devices 601 and 602 with a graded transmission, EC device 601 has a mirror transmission state to EC device 602 and EC devices 603 and 604 with fully clear transmission states. Column D shows EC devices 601 and 603 with a graded transmission state, EC device 602 with a fully tinted transmission state, and EC device 604 with fully clear transmission states. Column E shows EC devices 602 and 603 with a graded transmission, EC device 602 has a mirror transmission state to EC device 603 and EC devices 601 and 604 with fully clear transmission states. Column F shows EC devices 602 and 604 with a graded transmission state, where EC device 602 has a mirror transmission state with EC device 604, EC device 603 with a fully tinted transmission state, and EC device 601 with fully clear transmission states. Column G shows EC devices 603 and 604 with a graded transmission, EC device 603 has a mirror transmission state to EC device 604 and EC devices 601 and 602 with fully clear transmission states. Column H shows EC device 604 with a fully tinted transmission state, EC device 603 with a graded transmission and EC devices 602 and 601 with fully clear transmission states. Column A shows EC device 601 with a graded transmission and EC devices 602, 603, and 604 with fully clear transmission states. Column I shows EC device 604 with a fully tinted transmission state, EC device 602 with a graded transmission and EC devices 603, 602, and 601 with fully clear transmission states. As can be seen in columns A-I, the mirror transmission states between two EC devices can be at a direct junction between the two devices, as seen in column C, or can have an EC device in between, such as in column F. Additionally, while all the devices in columns A-I are capable of a graded transmission state, it can be imagined that there can be traditional electrochromics within the façade as well. In one embodiment, column F could include two traditional EC devices capable of tinting from fully clear to fully tinted, as seen with devices 601 and 603, and two EC devices capable of a graded transmission state with a mirror transmission, as described above, such as seen with devices 602 and 604. Moreover, the façade can include multiple rows of EC devices capable of a graded transmission, as seen in FIG. 7. Additionally, each row of the façade can be controlled using different algorithms. In one embodiment, the first row can be controlled using a first algorithm and a second row can be controlled using a second algorithm, where the first algorithm is different from the second algorithm. For example, the first row can be controlled using a glare algorithm while a second row can be controlled using a daylight algorithm. In essence, the factors used within the algorithms can be different, and as such, the factors used to control the first row can be different from the factors used to control the second row. In one embodiment, the first row can be controlled based in part on the position of the sun while the second row can be controlled based in part on the color rendering of the room. In another embodiment, the first row can be controlled based in part on the position of the sun while the second row can be controlled based in part on the temperature.

FIG. 7 includes a façade 700 that includes two columns and three rows of electrochromic devices able to tint in a graded transmission state. While the façade 700 has two columns and three rows, in one embodiment, the façade could have between 1 and 50 columns and between 2 and 50 rows of various shapes and sizes. Each of the electrochromic devices in the façade 700 can have a fully clear transmission state, a fully tinted transmission state, or a graded transmission state. In another embodiment, the façade 700 could include a combination of traditional electrochromics capable of having a fully tinted transmission and fully clear transmission and gradient electrochromic devices that can additionally include a graded transmission state. In other words, any of the EC devices shown in a fully tinted or fully clear transmission state could be a traditional EC device. The façade 700 can be seen at various different transmission states A-F. As can be seen in C, a first EC device can have a graded transmission state that goes from light to dark, and a second EC device adjacent to the first EC device can have a graded transmission state that minors the first EC device and goes from dark to light. While not shown, in another embodiment, two EC devices can be stacked one on top of the other, such as seen with EC devices 601 and 602 and it can be imagined that the first EC device can have a graded transmission state that goes from light to dark and a second EC device that goes from dark to light without being the exact minor of each other but having slight differences. It can also be imagined that the two EC devices in such an embodiment described above can have different sizes and/or different shapes.

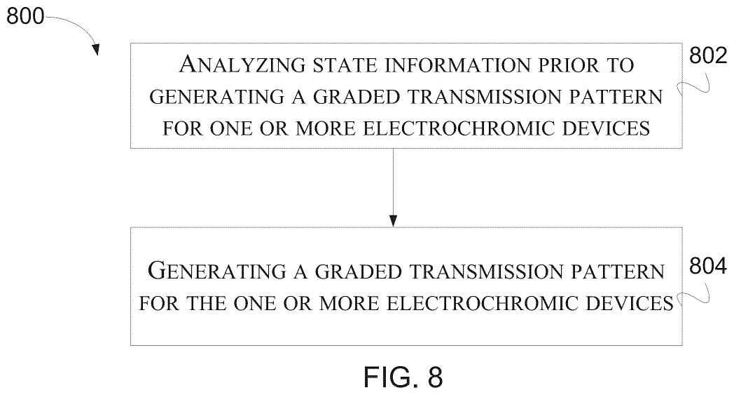

FIG. 8 includes a method of optimizing the tint pattern of any of the façades described above. The method can include analyzing state information prior to generating a graded transmission pattern for the one or more electrochromic devices, at block 802. The state information can include the measured illuminance, irradiance, or temperature received from the one or more sensors in the system, the number of rows and columns within the façade, any energy saving modes enabled, glare control algorithms, color rendering algorithms used to keep the CIELab within a certain range, the current tint levels of the one or more electrochromic devices. Different types of state information have been previously described. The state information may be collected at the I/O unit, such as a processor, from sources of state information, such as sensors, a calendar, a clock, a weather forecast, or the like. The collection of state information may occur nearly continuously, such as from a motion sensor, light sensor, or the like, on a periodic basis, such as once a minute, every ten minutes, hourly, or the like, or a combination thereof. In one embodiment, the processor 110 analyzes the state information. The method can further include receiving a preference or a weighing factor. The analyzed state information may be weighed and prioritized before generating a graded transmission pattern.

The method can continue, at block 804, by generating a graded transmission pattern for the entire façade. In one embodiment, the graded transmission pattern can follow an external factor like the sun. In another embodiment, the graded transmission pattern can include two EC devices with minor graded transmission states, where one device is in one row and the second device is in a second row. The graded transmission pattern can be any of the examples seen in FIGS. 6 and 7 or any combination therein. The processor can then send a signal to change the transmission states of the one or more electrochromic devices within a facade to the generated transmission pattern. A few exemplary scenes can include all EC devices for a window being at the highest transmission state (fully tinted), all EC devices for the window being at the lowest transmission state (bleached), different rows of EC devices for the window being at graded transmission states, and different rows of EC devices being at graded transmission states that mirror the graded transmission states of other rows. The graded transmission patterns may be generated when the building is originally built and configured or after a physical configuration of the controlled space is changed. The processor may subsequently delete or store the graded transmission pattern. After reading this specification, skilled artisans will understand that the order of actions in FIG. 8 may be changed. Furthermore, one or more actions may not be performed, and one or more further actions may be performed in generating the collection of scenes.

Other methods for operating the apparatus may be used. For example, the control logic may allow a significant change in state information to interrupt the method at nearly any point in the method to allow a change in the graded transmission pattern. The actions previously described for the method may be performed in a different order. Still further, some of the actions may be optional. For example, preferences or weighing factors do not have to be used, and a time-out feature for the transmission state of the one or more electrochromic devices may be used. After reading this specification, skilled artisans will be able to determine a methodology that is well suited for a particular application.

Many examples of tint patterns and their use have been illustrated and described. Such tint patterns for the windows are not limited to the examples illustrated or described. Other tint patterns can be validated and used without departing from the concepts described herein. Embodiments allow for simpler and more understandable control of EC devices for a window. Complex control systems are not required to be implemented. Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. An apparatus can include two or more electrochromic devices in at least two rows, where the two or more electrochromic devices c a first can include a first electrochromic device in a first row with a graded transmission state and a second electrochromic device in a second row with a graded transmission state; and a control device configured to generate a graded transmission pattern for the two or more electrochromic devices, where the gradient transmission state of the first electrochromic device is a minor to the gradient transmission state of the second electrochromic device.

Embodiment 2. The apparatus of embodiment 1, further can include a third electrochromic device on the first row, where the first electrochromic has a gradient transmission state.

Embodiment 3. The apparatus of embodiment 2, where gradient transmission state of the first electrochromic device is a minor to the gradient transmission state of the third electrochromic device.

Embodiment 4. The apparatus of embodiment 2, further can include a fourth electrochromic device on the second row, where the fourth electrochromic device has a fully clear transmission state.

Embodiment 5. The apparatus of embodiment 2, further can include a fourth electrochromic device on the second row, where the fourth electrochromic device has a fully tinted transmission state.

Embodiment 6. The apparatus of embodiment 2, further can include a fourth electrochromic device on the first row, where the fourth electrochromic device has a gradient transmission state.

Embodiment 7. The apparatus of embodiment 1, further can include a third electrochromic device on the first row, where the first electrochromic device has a fully tinted transmission state.

Embodiment 8. The apparatus of embodiment 7, further can include a fourth electrochromic device on the second row, where the fourth electrochromic device has a fully clear transmission state.

Embodiment 9. The apparatus of embodiment 7, further can include a fourth electrochromic device on the second row, where the fourth electrochromic device has a fully tinted transmission state.

Embodiment 10. The apparatus of embodiment 7, further can include a fourth electrochromic device on the first row, where the fourth electrochromic device has a gradient transmission state.

Embodiment 11. The apparatus of embodiment 1, further can include a third electrochromic device on the first row, where the first electrochromic device has a fully clear transmission state.

Embodiment 12. The apparatus of embodiment 11, further can include a fourth electrochromic device on the second row, where the fourth electrochromic device has a fully clear transmission state.

Embodiment 13. The apparatus of embodiment 11, further can include a fourth electrochromic device on the second row, where the fourth electrochromic device has a fully tinted transmission state.

Embodiment 14. The apparatus of embodiment 11, further can include a fourth electrochromic device on the first row, where the fourth electrochromic device has a gradient transmission state.

Embodiment 15. The apparatus of embodiment 1, where the two or more electrochromic devices comprise: a first transparent conductive layer; a first bus bar electrically connected to the first transparent conductive layer; a second bus bar parallel to the first bus bar electrically connected to the first transparent conductive layer; a second transparent conductive layer; a third bus bar orthogonal to the first bus bar and electrically connected to the second transparent conductive layer; a fourth bus bar parallel to the third bus bar and electrically connected to the second transparent conductive layer; a cathodic electrochemical layer between the first transparent conductive layer and the second transparent conductive layer; and an anodic electrochemical layer between the first transparent conductive layer and the second transparent conductive layer.

Embodiment 16. The system of embodiment 15, where each of the one or more electrochromic devices further comprises an ion conducting layer between the cathodic electrochemical layer and the anodic electrochemical layer.

Embodiment 17. The system of embodiment 16, where the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 18. The system of embodiment 15, where the cathodic electrochemical layer comprises WO₃, V₂O₅, MoO₃, Nb₂O₅, TiO₂, CuO, Ni₂O₃, NiO, Ir₂O₃, Cr₂O₃, Co₂O₃, Mn₂O_{3S}, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 19. The system of embodiment 15, where the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 20. The system of embodiment 15, where the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

Embodiment 21. A method of operating an apparatus can include: receiving a first input corresponding to state information; and at a control device, in response to receiving the first input, to generate a graded transmission pattern for two or more electrochromic devices configured in at least two rows, where the two or more electrochromic devices comprise a first electrochromic device in a first row with a graded transmission state and a second electrochromic device in a second row with a graded transmission state, where the gradient transmission state of the first electrochromic device is a minor to the gradient transmission state of the second electrochromic device.

Embodiment 22. A non-transitory computer readable medium containing a program of instructions for controlling two or more electrochromic devices, execution of which by a processor causes the steps of: receiving a first input corresponding to state information; and generating a first command to generate a graded transmission pattern for two or more electrochromic devices configured in at least two rows, where the two or more electrochromic devices comprise a first electrochromic device in a first row with a graded transmission state and a second electrochromic device in a second row with a graded transmission state, where the gradient transmission state of the first electrochromic device is a mirror to the gradient transmission state of the second electrochromic device.

Note that not all of the activities described above in the general description, or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus comprising:
two or more electrochromic devices configured in at least two rows, wherein the two or more electrochromic devices comprise a first electrochromic device in a first row with a graded transmission state and a second electrochromic device in a second row with a graded transmission state; and
a control device configured to generate a graded transmission pattern for the two or more electrochromic devices, wherein the gradient transmission state of the first electrochromic device is a minor to the gradient transmission state of the second electrochromic device.

2. The apparatus of claim 1, further comprising a third electrochromic device on the first row, wherein the first electrochromic has a gradient transmission state.

3. The apparatus of claim 2, wherein gradient transmission state of the first electrochromic device is a minor to the gradient transmission state of the third electrochromic device.

4. The apparatus of claim 2, further comprising a fourth electrochromic device on the second row, wherein the fourth electrochromic device has a fully clear transmission state.

5. The apparatus of claim 2, further comprising a fourth electrochromic device on the second row, wherein the fourth electrochromic device has a fully tinted transmission state.

6. The apparatus of claim 2, further comprising a fourth electrochromic device on the first row, wherein the fourth electrochromic device has a gradient transmission state.

7. The apparatus of claim 1, further comprising a third electrochromic device on the first row, wherein the first electrochromic device has a fully tinted transmission state.

8. The apparatus of claim 7, further comprising a fourth electrochromic device on the second row, wherein the fourth electrochromic device has a fully clear transmission state.

9. The apparatus of claim 7, further comprising a fourth electrochromic device on the second row, wherein the fourth electrochromic device has a fully tinted transmission state.

10. The apparatus of claim 7, further comprising a fourth electrochromic device on the first row, wherein the fourth electrochromic device has a gradient transmission state.

11. The apparatus of claim 1, further comprising a third electrochromic device on the first row, wherein the first electrochromic device has a fully clear transmission state.

12. The apparatus of claim 11, further comprising a fourth electrochromic device on the second row, wherein the fourth electrochromic device has a fully clear transmission state.

13. The apparatus of claim 11, further comprising a fourth electrochromic device on the second row, wherein the fourth electrochromic device has a fully tinted transmission state.

14. The apparatus of claim 11, further comprising a fourth electrochromic device on the first row, wherein the fourth electrochromic device has a gradient transmission state.

15. The apparatus of claim 1, wherein the two or more electrochromic devices comprise:
a first transparent conductive layer;
a first bus bar electrically connected to the first transparent conductive layer;
a second bus bar parallel to the first bus bar electrically connected to the first transparent conductive layer;
a second transparent conductive layer;
a third bus bar orthogonal to the first bus bar and electrically connected to the second transparent conductive layer;
a fourth bus bar parallel to the third bus bar and electrically connected to the second transparent conductive layer;
a cathodic electrochemical layer between the first transparent conductive layer and the second transparent conductive layer; and
an anodic electrochemical layer between the first transparent conductive layer and the second transparent conductive layer.

16. The system of claim 15, wherein each of the one or more electrochromic devices further comprises an ion conducting layer between the cathodic electrochemical layer and the anodic electrochemical layer.

17. The system of claim 15, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

18. The system of claim 15, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

19. A method of operating an apparatus comprising:
receiving a first input corresponding to state information; and
at a control device, in response to receiving the first input, to generate a graded transmission pattern for two or more electrochromic devices configured in at least two rows, wherein the two or more electrochromic devices comprise a first electrochromic device in a first row with a graded transmission state and a second electrochromic device in a second row with a graded transmission state, wherein the gradient transmission state of the first electrochromic device is a mirror to the gradient transmission state of the second electrochromic device.

20. A non-transitory computer readable medium containing a program of instructions for controlling two or more electrochromic devices, execution of which by a processor causes the steps of:
receiving a first input corresponding to state information; and
generating a first command to generate a graded transmission pattern for two or more electrochromic devices configured in at least two rows, wherein the two or more electrochromic devices comprise a first electrochromic device in a first row with a graded transmission state and a second electrochromic device in a second row with a graded transmission state, wherein the gradient transmission state of the first electrochromic device is a mirror to the gradient transmission state of the second electrochromic device.
